(19) United States
(12) Patent Application Publication
(10) Pub. No.: US 2023/0285999 A1
(43) Pub. Date: Sep. 14, 2023

(54) DUAL FEED COLD SPRAY NOZZLE WITH SEPARATE TEMPERATURE AND FEEDING RATE CONTROL

(71) Applicant: Intel Corporation, Santa Clara, CA (US)

(72) Inventors: Wenhao Li, Chandler, AZ (US); Feras Eid, Chandler, AZ (US); Paul Diglio, Gaston, OR (US); Jiraporn Seangatith, Chandler, AZ (US)

(73) Assignee: Intel Corporation, Santa Clara, CA (US)

(21) Appl. No.: 17/694,302

(22) Filed: Mar. 14, 2022

(51) Int. Cl. B05B 7/14; B05B 7/16

(52) U.S. Cl. CPC B05B 7/1486; B05B 7/1626

(57) ABSTRACT

Cold-spray nozzles, systems, and techniques are described herein related to manufacturing implementations of efficient film deposition. A deposition system includes multiple feed systems to deliver solid powder materials at controlled feed rates and temperatures, and a nozzle, including convergent and divergent sections and connections to the feed systems, to receive a carrier fluid in the convergent section and to spray the carrier fluid and the solid powder materials out of the divergent section. A nozzle includes multiple ports to receive solid powder materials for admission into a carrier fluid, with one or more ports in the convergent section and one or more ports in the divergent section. A method may include delivering a carrier fluid to a nozzle, heating multiple solid powder materials, delivering these solid powder materials to the nozzle, and spraying the solid powder materials out of a divergent section of the nozzle.

### BACKGROUND

Composite films can solve problems that more simple films cannot, but manufacturing these composite films poses new problems.

By mixing materials with complementary physical properties, films can be made with, for example, thermal conductivities higher than silicon and coefficients of thermal expansion that closely match silicon and so improve thermal management and warpage control. However, co-depositing particles with differing physical properties, such as density, modulus, and melting point, can be problematic when using conventional techniques for cold-spray deposition. The traditional cold-spray feeding system has trouble with depositing particles with different traits, as treatment together in the cold-spray nozzle would result in different deposition efficiencies and poor control of film composition. As process temperature is limited by the particles' lowest melting point, different melting points would similarly result in mismatched deposition efficiencies and poor control of film composition.

Although a layer-by-layer approach can sometimes be used as a workaround to make films with vastly different components, deposition process parameters need to be developed for each layer of deposition. These alternating layers also impose adhesion risks and latent material defects at their interfaces. Furthermore, this alternating-layer approach requires the repeated loading of different powders. This low-throughput, non-continuous process is not conducive to high-volume manufacturing.

Thus, new methods of cold spraying are needed to enable high-throughput manufacturing of these useful composite films.

### BRIEF DESCRIPTION OF THE DRAWINGS

The subject matter of the present disclosure is particularly pointed out and distinctly claimed in the concluding portion of the specification. The foregoing and other features of the present disclosure will become more fully apparent from the following description and appended claims, taken in conjunction with the accompanying drawings. It is understood that the accompanying drawings depict only several embodiments in accordance with the present disclosure and are, therefore, not to be considered limiting of its scope. The disclosure will be described with additional specificity and detail through use of the accompanying drawings, such that the advantages of the present disclosure can be more readily ascertained, in which:

FIG. 1 illustrates a cross-sectional side view of an example cold-spray system, including multiple feed systems and a nozzle;

FIG. 2 illustrates a cross-sectional side view of an example cold-spray system, including multiple feed systems and a nozzle;

FIG. 3 illustrates a cross-sectional side view of an example cold-spray system, including multiple feed systems and a nozzle;

FIG. 4 illustrates a cross-sectional side view of an example nozzle, including a variety of ports available for making connections to the nozzle;

FIG. 5 illustrates various processes or methods for spraying solid powder materials from a nozzle for film deposition;

FIG. 6 illustrates a cross-sectional side view of an example cold-spray system with a nozzle, including many ports available for making connections to multiple feed systems;

FIG. 7 illustrates a cross-sectional side view of an example cold-spray system with multiple feed systems and a nozzle, which includes many ports and port plugs;

FIG. 8 illustrates a cross-sectional side view of an example cold-spray system with multiple feed systems and a nozzle, which includes many ports and port plugs; and

FIG. 9 illustrates an electronic system, specifically a computing device, all arranged in accordance with at least some implementations of the present disclosure.

### DETAILED DESCRIPTION

In the following detailed description, reference is made to the accompanying drawings that show, by way of illustration, specific embodiments in which the claimed subject matter may be practiced. These embodiments are described in sufficient detail to enable those skilled in the art to practice the subject matter. It is to be understood that the various embodiments, although different, are not necessarily mutually exclusive. For example, a particular feature, structure, or characteristic described herein, in connection with one embodiment, may be implemented within other embodiments without departing from the spirit and scope of the claimed subject matter. References within this specification to “one embodiment” or “an embodiment” mean that a particular feature, structure, or characteristic described in connection with the embodiment is included in at least one implementation encompassed within the present description. Therefore, the use of the phrase “one embodiment” or “in an embodiment” does not necessarily refer to the same embodiment. In addition, it is to be understood that the location or arrangement of individual elements within each disclosed embodiment may be modified without departing from the spirit and scope of the claimed subject matter. The following detailed description is, therefore, not to be taken in a limiting sense, and the scope of the subject matter is defined only by the appended claims, appropriately interpreted, along with the full range of equivalents to which the appended claims are entitled. In the drawings, like numerals refer to the same or similar elements or functionality throughout the several views, and that elements depicted therein are not necessarily to scale with one another, rather individual elements may be enlarged or reduced in order to more easily comprehend the elements in the context of the present description.

The terms “over,” “to,” “between,” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

Throughout the specification, and in the claims, the term “connected” means a direct connection, such as electrical, mechanical, or magnetic connection between the things that are connected, without any intermediary devices.

The term “ceramic” means any inorganic, nonmetallic material and can include diamond.

The term “coupled” means a direct or indirect connection, such as a direct electrical, mechanical, thermal, magnetic, or fluidic connection between the things that are connected or an indirect connection, through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The vertical orientation is in the z-direction and it is understood that recitations of “top,” “bottom,” “above,” and “below” refer to relative positions in the z-dimension with the usual meaning. However, it is understood that embodiments are not necessarily limited to the orientations or configurations illustrated in the figure.

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional,” “profile,” and “plan” correspond to orthogonal planes within a cartesian coordinate system. Thus, cross-sectional and profile views are taken in the x-z and y-z planes, and plan views are taken in the x-y plane. Typically, profile views in the x-z plane are cross-sectional views. Where appropriate, drawings are labeled with axes to indicate the orientation of the figure.

Embodiments of the present description relate to the use of multiple material delivery systems to provide solid powder materials to a single cold-spray nozzle. Such systems may include independent temperature and feed rate controls for efficient film deposition. Such techniques improve manufacturing products and processes, both in the areas of high-volume throughput and efficiency, as well as end-product quality and reliability. In some embodiments, a deposition system includes two feed systems, each including a controller, a heater, and a conveyor, to deliver solid powder materials, and to control feed rates and temperatures of the solid powder materials, and a nozzle with convergent and divergent sections and connections to the feed systems. The nozzle is to receive a carrier fluid in the convergent section and to spray the carrier fluid and the solid powder materials out of the divergent section. In some embodiments, an apparatus includes a nozzle (with a convergent section, a divergent section, and a throat between) to receive a gas in the convergent section, to accelerate the gas, and to send the gas out of the divergent section, and multiple ports on the nozzle to receive solid powder materials for admission into the gas, with one or more ports in the convergent section and one or more ports in the divergent section. In some embodiments, a method includes delivering a carrier gas to a nozzle, heating multiple solid powder materials, delivering these solid powder materials to the nozzle, and spraying the solid powder materials out of a divergent section of the nozzle.

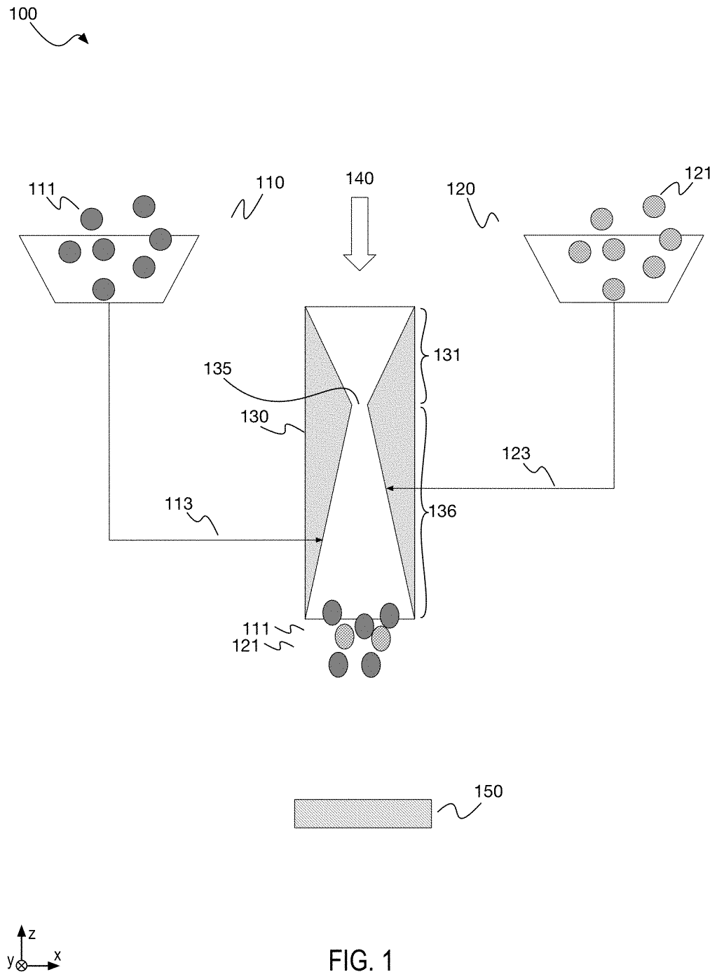

FIG. 1 illustrates a cross-sectional side view of an example cold-spray system 100, including multiple feed systems 110, 120 and a nozzle 130, arranged in accordance with at least some implementations of the present disclosure. As shown in FIG. 1, nozzle 130 includes a convergent section 131 and a divergent section 136. A gas 140, whose direction of flow is shown by the downward arrow above nozzle 130, flows downward and into nozzle 130. Gas 140 is accelerated in convergent section 131, which is where nozzle 130 narrows the flow of gas 140 downward to a throat 135, which separates convergent section 131 and divergent section 136. Gas 140 is accelerated again as it expands in divergent section 136, which is where nozzle 130 widens the flow of gas 140 from throat 135 downward. Feed system 110 delivers a solid powder material 111 via connection 113 to nozzle 130 and its divergent section 136. Feed system 120 independently delivers a solid powder material 121 to a higher position in nozzle 130 and its divergent section 136 via connection 123. Gas 140 acts as a carrier fluid for solid powder materials 111, 121. Solid powder materials 111, 121 are mixed and accelerated in, and carried downward by gas 140. The mixture of gas 140 and solid powder materials 111, 121 spray out of divergent section 136 and nozzle 130 towards substrate 150. The spraying of such mixtures can be used to deposit films made of solid powder materials 111, 121 onto substrate 150.

The independent feed systems 110, 120 allow for separate deliveries of and controls for solid powder materials 111, 121, such as independent controls for feed rates and temperatures and physically distinct delivery positions. These independent controls can make for different and better films deposited on substrate 150. Without independent feed systems 110, 120, solid powder materials 111, 121 must be mixed and then delivered to a cold-spray nozzle 130 together, which limits the flexibility of film deposition control and even what films can be deposited.

The independent feed systems 110, 120 allow for independent feed rates of solid powder materials 111, 121. The composition of the film deposited by the spray from nozzle 130 is determined not just by the constituent solid powder materials 111, 121, but also by the ratio of the respective feed rates of feed systems 110, 120. Independent feed systems 110, 120 allow for not only combining different solid powder materials 111, 121, but also for combining solid powder materials 111, 121 in differing proportions over time. In some embodiments, solid powder material 111 or 121 is delivered at a constant feed rate and the feed rate for solid powder material 121 or 111 is varied between film depositions. In some embodiments, solid powder material 111 or 121 is delivered at a constant feed rate and the feed rate for solid powder material 121 or 111 is varied within a film deposition.

The independent feed systems 110, 120 also allow for independent heating of solid powder materials 111, 121 before delivery to nozzle 130. Without independent heating, mixture temperatures can be excessively limited by the lower of the melting points of the various constituent materials. If a high-melting point material is insufficiently heated, it may be too hard for optimal particle retention in the final composite film. If a low-melting point material is excessively heated, it may melt or be too soft and agglomerate in nozzle 130. In some embodiments, solid powder materials 111, 121 have substantially different melting points and independent feed systems 110, 120 allow for heating each material to delivery temperatures close to but below their respective melting points. In some embodiments, solid powder materials 111 or 121 are heated to temperatures with margins below their melting points to account for heating from gas 140 or other solid powder materials. In some embodiments, solid powder material 111 includes a metal and solid powder material 121 includes a polymer. Any suitable metals, polymers, ceramics, or other materials can be used. In some embodiments, solid powder material 111 or 121 includes copper. In some embodiments, solid powder material 111 or 121 includes diamond. In some embodiments, solid powder material 111 or 121 includes aluminum or nickel. In some embodiments, solid powder material 111 or 121 includes polyimide. In some embodiments, solid powder material 111 or 121 is heated to a constant delivery temperature and the delivery temperature for solid powder material 121 or 111 is varied.

The separate connections 113, 123 allow for different positioning of the respective deliveries of solid powder materials 111, 121. The different positions of connections 113, 123 can result in different delivery parameters for solid powder materials 111, 121. Although in the example of FIG. 1, solid powder materials 111, 121 are both delivered to divergent section 136, connection 123 delivers solid powder material 121 higher in nozzle 130 than connection 113 delivers solid powder material 111. Solid powder material 121 is accelerated by gas 140 for longer and to a higher velocity than solid powder material 111. In some embodiments, higher positions of connections 113, 123 and higher powder velocities of solid powder materials 111 or 121 are used to improve the deposition of a film on substrate 150. In some embodiments, higher powder velocities are used to deposit harder solid powder materials 111 or 121. In some embodiments, higher powder velocities are used to deposit solid powder materials 111 or 121 with higher melting points.

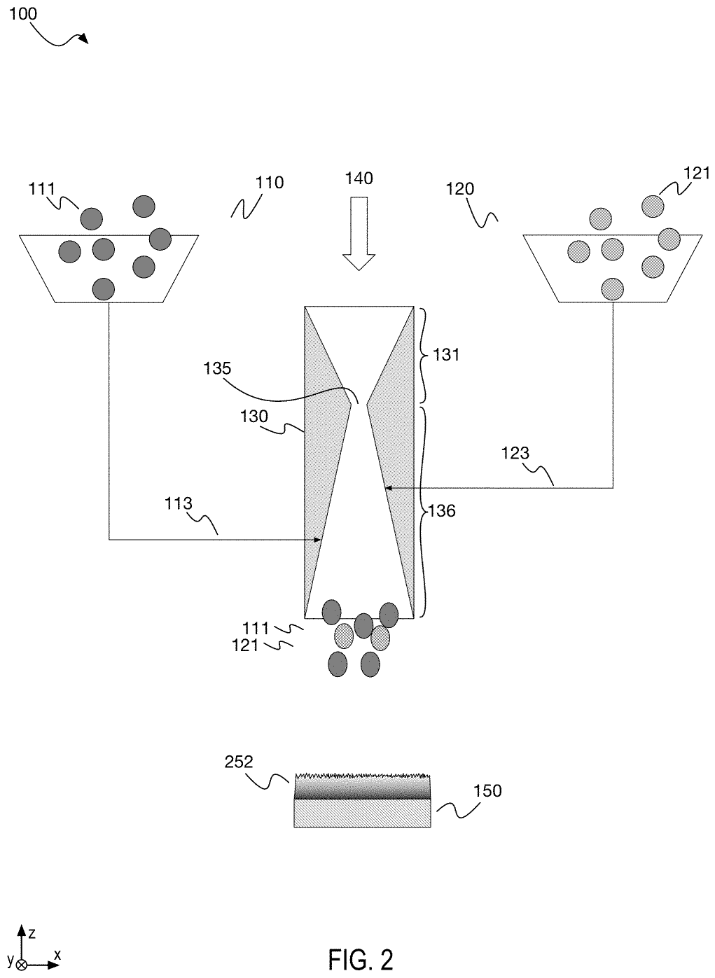

FIG. 2 illustrates a cross-sectional side view of an example cold-spray system 100, including multiple feed systems 110, 120 and nozzle 130, arranged in accordance with at least some implementations of the present disclosure. As shown in FIG. 2, nozzle 130 includes a convergent section 131 and a divergent section 136. Feed system 110 delivers solid powder material 111 via connection 113 to nozzle 130 and its divergent section 136. Feed system 120 independently delivers solid powder material 121 to a higher position in nozzle 130 and its divergent section 136 via connection 123. Gas 140, whose direction of flow is shown by the downward arrow above nozzle 130, acts as a carrier fluid for solid powder materials 111, 121. Gas 140 flows downward and into nozzle 130. Gas 140 enters convergent section 131 and goes through throat 135 of nozzle 130. Solid powder materials 111, 121 are mixed and accelerated in, and carried downward by gas 140. The mixture of gas 140 and solid powder materials 111, 121 spray out of divergent section 136 and nozzle 130 towards substrate 150. Solid powder materials 111, 121 are deposited on substrate 150 to form a deposited film 252. As seen in FIG. 2, deposited film 252 has a graded composition. Deposited film 252 is a gradient film with darker composition at its interface with substrate 150 and lighter composition as a z-height of deposited film 252 increases to the nozzle side of deposited film 252.

The composition of deposited film 252 depends on the constituent solid powder materials 111, 121, but also on the certain delivery conditions of solid powder materials 111, 121, such as temperature and feed rate. As such, the composition of deposited film 252 can be varied by varying these certain delivery conditions of solid powder materials 111, 121. With independent feed systems 110, 120, such conditions can be more easily varied between the deposition of one film and the next. Such conditions can also be varied during the deposition of a single film to create a film with varying composition, such as deposited film 252, which is seen in FIG. 2 to have a graded composition. In some embodiments, solid powder material 111 or 121 is delivered at a constant feed rate and the feed rate for solid powder material 121 or 111 is varied within a film deposition. In some embodiments, the feed rates for solid powder materials 111, 121 are both varied within a film deposition. In some embodiments, solid powder material 111 includes a metal, such as copper, aluminum, or nickel, solid powder material 121 includes a polymer, such as polyimide, and deposited film 252 is a metal-polymer co-deposited film. In some embodiments, solid powder material 111 or 121 is heated to a constant delivery temperature and the delivery temperature for solid powder material 121 or 111 is varied. In some embodiments, the delivery temperatures for solid powder materials 111, 121 are both varied within a film deposition. In some embodiments, powder velocities for one or both solid powder materials 111 or 121 are varied within a film deposition. In some embodiments, the positions of one or both of connections 113, 123 are varied between film depositions. In some embodiments, the positions of one or both of connections 113, 123 are varied within a film deposition.

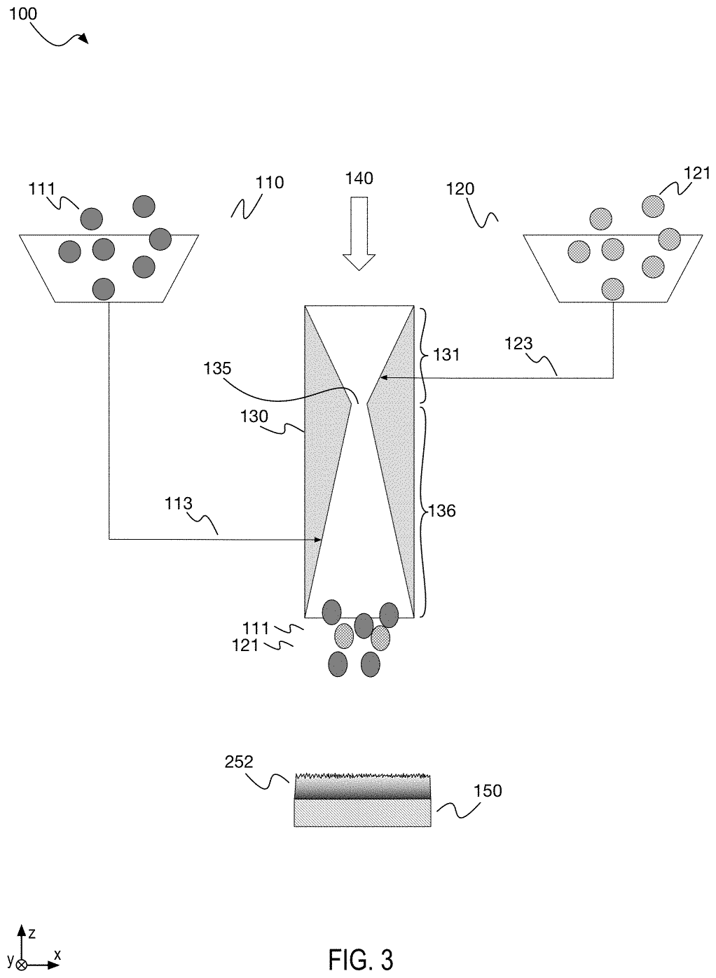

FIG. 3 illustrates a cross-sectional side view of an example cold-spray system 100, including multiple feed systems 110, 120 and nozzle 130, arranged in accordance with at least some implementations of the present disclosure. As shown in FIG. 3, nozzle 130 includes a convergent section 131 and a divergent section 136. Feed system 110 delivers solid powder material 111 via connection 113 to nozzle 130 and its divergent section 136. Feed system 120 independently delivers solid powder material 121 to a higher position in nozzle 130, in its convergent section 131, via connection 123. Gas 140, whose direction of flow is shown by the downward arrow above nozzle 130, acts as a carrier fluid for solid powder materials 111, 121. Gas 140 flows downward and into nozzle 130. Gas 140 enters convergent section 131, where solid powder material 121 is mixed into gas 140. Gas 140 carries solid powder material 121 through throat 135 of nozzle 130. Solid powder material 111 is mixed into gas 140 in divergent section 136. Solid powder materials 111, 121 are accelerated in and carried downward by gas 140. The mixture of gas 140 and solid powder materials 111, 121 spray out of divergent section 136 and nozzle towards substrate 150. Solid powder materials 111, 121 are deposited on substrate 150 to form deposited film 252.

FIG. 3 shows that separate and different physical positions on nozzle 130 can be used for making connections 113, 123 to feed systems 110, 120 for the delivery of solid powder materials 111, 121. Different physical locations for connections 113, 123 can result in different delivery conditions for solid powder materials 111, 121 and so in different film characteristics. A higher position on nozzle 130 (further from the spray end) for connection 113 or 123 from feed system 110 or 120 can result in higher particle velocity. In some embodiments, higher positions of connections 113, 123 and higher powder velocities of solid powder materials 111 or 121 are used to improve the deposition of deposited film 252 on substrate 150. In some embodiments, higher powder velocities are used to deposit harder solid powder materials 111 or 121. In some embodiments, higher powder velocities are used to deposit solid powder materials 111 or 121 with higher melting points.

As shown in FIG. 3 with connection 123, connections 113, 123 can be made at positions on nozzle 130 in convergent section 131. Delivering solid powder materials 111, 121 into nozzle 130 in convergent section 131 can be used to expose the materials to the higher temperature and pressure conditions there. In some embodiments, the positions of one or both of connections 113, 123 are in convergent section 131. In some embodiments, the positions of one or both of connections 113, 123 are in divergent section 136. In some embodiments, the position of one of connections 113, 123 is in convergent section 131, and the position of the other of connections 113, 123 is in divergent section 136.

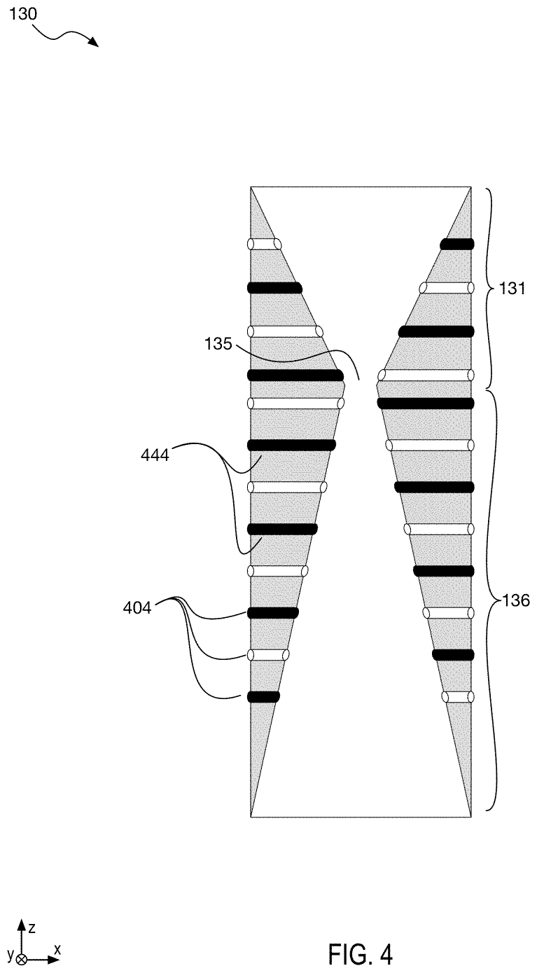

FIG. 4 illustrates a cross-sectional side view of an example nozzle 130, including a variety of ports 404 available for making connections to nozzle 130, arranged in accordance with at least some implementations of the present disclosure. Multiple ports 404 are situated at multiple, distinct positions along and around nozzle 130, including multiple ports 404 in convergent section 131, multiple ports 404 at throat 135, and multiple ports 404 in divergent section 136. Some of ports 404 have port plugs 444 and have been made unavailable for connecting to nozzle 130. Other ports 404, with and without port plugs 444, may be off of the cross-sectional viewing plane and so not shown in FIG. 4.

Nozzle 130 and its variety of ports 404 enable a variety of connections from feed systems for delivering solid powder materials for cold-spraying and subsequent film deposition. Nozzle 130 and its variety of ports 404 so facilitate the variety of controls already discussed, such as multiple feed rates and temperatures, as well as different connection positions. Nozzle 130 can be used with one, two, or more feed connections connecting to one, two, or more ports 404. One or more ports 404 may be unused. In some embodiments, two feed systems deliver solid powder materials to two ports 404 for depositing one film and are then connected to two different ports 404 for depositing a second film. In some embodiments, four feed systems deliver solid powder materials to four ports 404 for depositing one film. In some embodiments, four feed systems deliver solid powder materials to four ports 404 and various combinations of the four ports 404 are selected from for depositing a variety of different films.

Optional port plugs 444 can be used to block off one or more ports 404 from connecting to feed systems configured to deliver materials to nozzle 130. In nozzles 130 with, e.g., common headers for connecting multiple ports 404 to materials feed systems, port plugs 444 can be used to determine which one or more ports 404 will receive materials for spraying. Port plugs 444 can be made of any suitable design or materials. In some embodiments, port plugs 444 are push-to-fit plugs. In some embodiments, port plugs 444 are screw-in plugs. In some embodiments, port plugs 444 include multiple materials. In some embodiments, port plugs 444 include a harder material on the carrier fluid side and a softer material on the solid powder material side. In some embodiments, two feed systems deliver solid powder materials to two ports 404 for depositing one film and are then connected to third and fourth ports 404 for depositing a second film, and plug ports 444 are used to block off the first two ports 404. In some embodiments, unused ports 404 do not use port plugs 444 but are configured such that port plugs 444 are not necessary even when gas 140 is flowing through nozzle 130.

Optional port plugs 444 can also be used to block off one or more ports 404 on the interior interface of nozzle 130 to minimize or even eliminate, e.g., disruptions to flow through nozzle 130 by carrier fluids and solid powder materials. One or more ports 404 can also be unused without plugging by port plugs 444. In some embodiments, unused ports 404 do not use port plugs 444 but are configured such that port plugs 444 are not necessary even when gas 140 is flowing through nozzle 130.

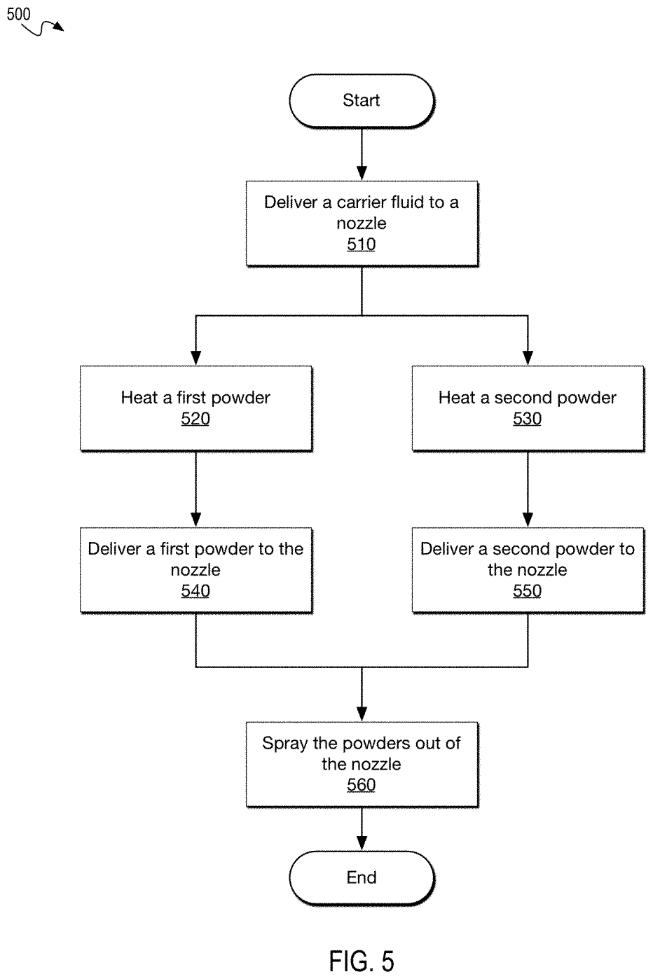

FIG. 5 illustrates various processes or methods 500 for spraying solid powder materials from a nozzle for film deposition, arranged in accordance with at least some implementations of the present disclosure.

As shown in FIG. 5, the process includes a carrier fluid, such as a pressurized gas, being delivered to a nozzle for spraying. This is shown in operation 510. The nozzle has convergent and divergent sections, and the gas is injected into the convergent section. The gas is forced through the nozzle and will accelerate as it expands out of the divergent section. The gas can be driven by any suitable means, e.g., a compressor or a sufficiently large vessel containing pressurized gas. The gas is injected to carry at least two solid powder materials out of the nozzle.

The two solid powder materials are heated, the first powder in operation 520 and the second powder in operation 530. The two solid powder materials can each be heated independently of the other, simultaneously or in any order, to whatever temperature is appropriate for the materials and the application, e.g., to just below that material's melting point, or whatever temperature is otherwise desired. The materials can be heated by any suitable means, e.g., electric heater, gas flame, or heat exchanger. In some embodiments, heaters are controlled automatically and in conjunction with temperature sensors, e.g., a thermocouple or a resistance temperature detector. In some embodiments, heater controllers are simple thermostats including, e.g., temperature-activated relays. In some embodiments, heater controllers include more-sophisticated central processors programmed for the purpose. In some embodiments, heaters are controlled manually by operators monitoring displayed temperatures, e.g., on temperature meters. In some embodiments, the two solid powder materials are heated separately to different temperatures, each to just below their respective melting points. In some embodiments, more than two solid powder materials are heated. In some embodiments, three solid powder materials are heated each by a different heater. In some embodiments, the three solid powder materials include a metal, such as copper, aluminum, or nickel; a polymer, such as polyimide; and a ceramic, such as diamond; and the deposited film is a metal-ceramic-polymer co-deposited film. In some embodiments, four solid powder materials are heated each by an independent heater. In some embodiments, the four solid powder materials include a metal, such as copper, aluminum, or nickel; a polymer, such as polyimide; and a ceramic, such as diamond; and the deposited film is a metal-ceramic-polymer co-deposited film.

The two solid powder materials are delivered to the nozzle, the first powder in operation 540 and the second powder in operation 550. The solid powder materials can be delivered simultaneously and form a mixed film or sequentially (in any order) and form alternating layers. The solid powder materials can be delivered by any suitable means, e.g., by auger (or screw) conveyors or by pressurized gas with appropriate controls (such as valves). In some embodiments, feed systems include augers delivering solid powder materials from pressurized supplies. The two solid powder materials can be delivered to separate positions on the nozzle. The two solid powder materials can be delivered to an identical position on the nozzle. In some embodiments, the two solid powder materials are delivered to the convergent section of the nozzle. In some embodiments, the two solid powder materials are delivered to the divergent section of the nozzle. In some embodiments, one solid powder material is delivered to the convergent section of the nozzle and the other solid powder material is delivered to the divergent section of the nozzle.

The two solid powder materials can be delivered to the nozzle independently and at different feed rates. In some embodiments, separate conveyors are controlled independently by operators monitoring appropriate parameters, e.g., gas flow rate, mass feed rate, feed temperatures, film thickness, etc. In some embodiments, separate conveyors are controlled automatically by programmed processors monitoring appropriate system parameters, e.g., gas flow rate, mass feed rate, feed temperatures, film thickness, etc. In some embodiments, the programmed processors automatically controlling conveyors and their feed rates also automatically control the heaters and temperatures of the solid powder materials. In some embodiments, programmed processors separately control the feed rates of two solid powder materials and vary one or more feed rates to create deposited films with graded variations in composition. In some embodiments, a feed rate for a first solid powder material is increased while a feed rate for a second solid powder material is held constant. In some embodiments, a feed rate for a first solid powder material is decreased while a feed rate for a second solid powder material is held constant.

In some embodiments, more than two solid powder materials are delivered to the nozzle. In some embodiments, three solid powder materials are delivered each by a different auger conveyor and at a different feed rate. In some embodiments, four solid powder materials are delivered at the same feed rate but by independent auger conveyors.

The two solid powder materials are carried by the accelerated gas out of the divergent section of the nozzle as spray in operation 560. Having been delivered to the nozzle and the carrier gas within it, the solid powder materials are mixed with each other and entrained in the gas. Although some solid powder materials may deposit on, e.g., some surface in the nozzle, the gas and remaining powder together spray out the divergent section of the nozzle towards a substrate for deposition as a film.

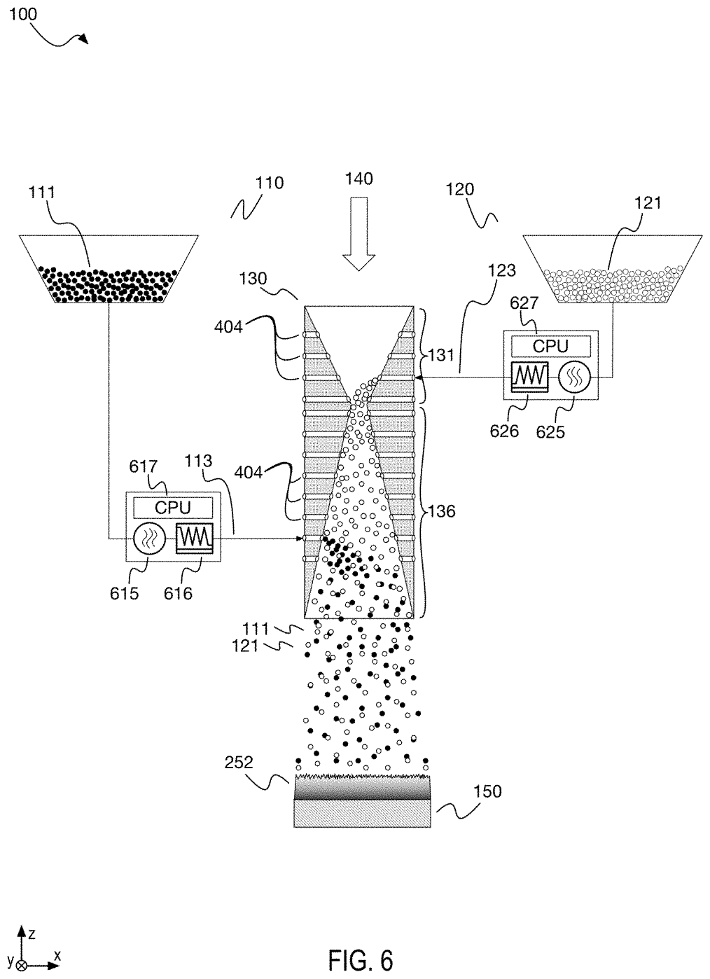

FIG. 6 illustrates a cross-sectional side view of an example cold-spray system 100 with nozzle 130, including many ports 404 available for making connections to multiple feed systems 110, 120, arranged in accordance with at least some implementations of the present disclosure. As shown in FIG. 6, nozzle 130 includes a convergent section 131, a divergent section 136, and many ports 404 available for making connections to feed systems 110, 120 (or other feed systems). Feed system 110 delivers solid powder material 111 via connection 113 to nozzle 130 and its divergent section 136. Feed system 110 includes a heater 615, a conveyor 616, and a controller 617. Feed system 120 independently delivers solid powder material 121 to a higher position in nozzle 130, in its convergent section 131, via connection 123. Feed system 120 includes a heater 625, a conveyor 626, and a controller 627.

Gas 140, whose direction of flow is shown by the downward arrow above nozzle 130, acts as a carrier fluid for solid powder materials 111, 121. Gas 140 flows downward and into nozzle 130. Gas 140 enters convergent section 131. Solid powder material 121 can be seen emerging from connection 123 into convergent section 131, where it is entrained in gas 140. Solid powder material 121 is carried by gas 140 into divergent section 136. Solid powder material 111 can be seen emerging from connection 113 into divergent section 136, where it is entrained in gas 140 and mixed with solid powder material 121. Solid powder materials 111, 121 are accelerated in and carried downward by gas 140. The mixture of gas 140 and solid powder materials 111, 121 spray out of divergent section 136 and nozzle 130 towards substrate 150. Solid powder materials 111, 121 are deposited on substrate 150 to form a deposited film 252, which can be seen to have a graded composition. Deposited film 252 is a gradient film with darker composition at its interface with substrate 150 and lighter composition as a z-height of deposited film 252 increases to the nozzle side of deposited film 252.

Feed systems 110, 120 include heaters 615, 625, and controllers 617, 627, respectively. Heaters 615, 625 allow solid powder materials 111, 121 to be heated independently of the other and to whatever temperature is appropriate or otherwise desired for a given material and application, e.g., to just below that material's melting point. Heaters 615, 625 can use any suitable means, e.g., electric heater, gas flame, or heat exchanger. Heaters 615, 625 are controlled by controllers 617, 627, respectively. In some embodiments, heaters 615, 625 are controlled automatically by controllers 617, 627 and in conjunction with temperature sensors, e.g., a thermocouple or a resistance temperature detector, to maintain separate constant feed temperatures for solid powder materials 111, 121. In some embodiments, heater controllers 617, 627 include sophisticated central processors programmed with separate temperature profiles that vary over time. In some embodiments, solid powder materials 111, 121 are heated separately to different temperatures, each to just below their respective melting points. In some embodiments, additional feed systems deliver additional solid powder materials which are heated by additional heaters. In some embodiments, three solid powder materials are heated each by a different heater. In some embodiments, four solid powder materials are heated each by a different heater.

Feed systems 110, 120 include conveyors 616, 626, and controllers 617, 627, respectively. Conveyors 616, 626 allow solid powder materials 111, 121 to be delivered independently of the other and at whatever feed rate is desired, e.g., for a given film composition. Conveyors 616, 626 can deliver solid powder materials 111, 121 by any suitable means, e.g., by auger (or screw) conveyors or by pressurized gas with appropriate controls (such as valves). In some embodiments, conveyors 616, 626 are augers delivering solid powder materials 111, 121 from pressurized supplies. Solid powder materials 111, 121 can be delivered to separate positions on nozzle 130. Solid powder materials 111, 121 can be delivered to an identical position on nozzle 130. In some embodiments, solid powder materials 111, 121 are delivered to convergent section 131 of nozzle 130. In some embodiments, solid powder materials 111, 121 are delivered to divergent section 136 of nozzle 130. In some embodiments, and as shown in FIG. 6, solid powder material 121 is delivered to convergent section 131 of nozzle 130 and solid powder material 111 is delivered to divergent section 136 of nozzle 130.

Solid powder materials 111, 121 can be delivered to nozzle 130 independently and at different feed rates. In some embodiments, conveyors 616, 626 are controlled automatically by the programmed processors of controllers 617, 627, which monitor appropriate system parameters, e.g., gas flow rate, mass feed rate, feed temperatures, film thickness, etc. In some embodiments, conveyors 616, 626 are controlled automatically by controllers 617, 627 to maintain separate constant feed rates for solid powder materials 111, 121. In some embodiments, conveyor controllers 617, 627 include sophisticated central processors programmed with separate feed-rate profiles that vary over time. In some embodiments, controllers 617, 627 automatically controlling conveyors 616, 626 and their feed rates also automatically control heaters 615, 625 and the feed temperatures of solid powder materials 111, 121. In some embodiments, controllers 617, 627 separately control the feed rates of solid powder materials 111, 121 and vary one or more feed rates to create deposited films with graded variations in composition. In some embodiments, a feed rate for solid powder material 111 is increased while a feed rate for solid powder material 121 is held constant. In some embodiments, a feed rate for solid powder material 111 is decreased while a feed rate for solid powder material 121 is held constant. In some embodiments, additional solid powder materials are delivered to nozzle 130. In some embodiments, a third solid powder material is delivered each by a third auger conveyor and at a third feed rate. In some embodiments, four solid powder materials are delivered at the same feed rate but by independent auger conveyors.

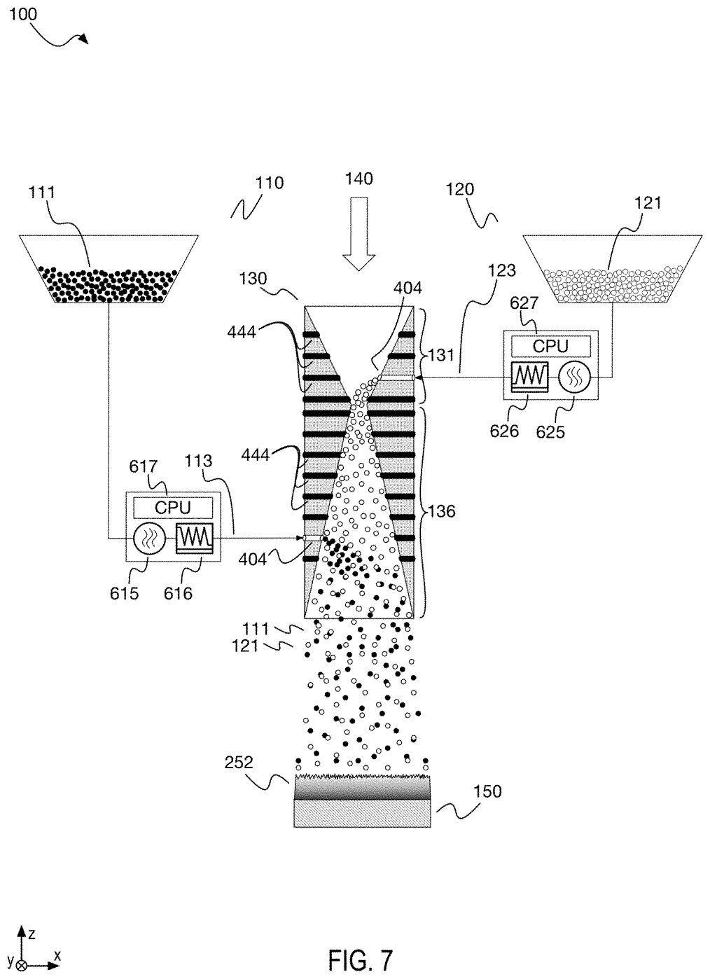

FIG. 7 illustrates a cross-sectional side view of an example cold-spray system 100 with multiple feed systems 110, 120 and nozzle 130, which includes many ports 404 and port plugs 444, arranged in accordance with at least some implementations of the present disclosure. As shown in FIG. 7, much like the example shown in FIG. 6, nozzle 130 includes a convergent section 131, a divergent section 136, and many ports 404 for making connections to feed systems 110, 120 (or other feed systems). Except for the two ports 404 used for making connections 113, 123 to feed systems 110, 120, all ports 404 shown are filled by port plugs 444 and blocked off from making further connections to feed systems. Feed systems 110, 120 independently deliver solid powder materials 111, 121 to nozzle 130. Feed systems 110, 120 include heaters 615, 625, conveyors 616, 626, and controllers 617, 627. Gas 140 flows downward and into nozzle 130, where it acts as a carrier fluid for solid powder materials 111, 121. The mixture of gas 140 and solid powder materials 111, 121 spray out of divergent section 136 and nozzle 130 towards substrate 150. Solid powder materials 111, 121 are deposited on substrate 150 to form a deposited film 252, which can be seen to have a graded composition. Deposited film 252 is a gradient film with darker composition at its interface with substrate 150 and lighter composition as a z-height of deposited film 252 increases to the nozzle side of deposited film 252.

Optional port plugs 444 can be used to block off one or more ports 404 from connecting to feed systems 110, 120 (or other feed systems) configured to deliver materials to nozzle 130. In some embodiments, in nozzles 130 with, e.g., common headers for connecting multiple ports 404 to feed systems 110, 120, port plugs 444 can be used to determine which one or more ports 404 will receive materials for spraying. In some embodiments, feed systems 110, 120 deliver solid powder materials 111, 121 to two ports 404 for depositing one film and are then connected to a third and fourth ports 404 for depositing a second film, and plug ports 444 are used to block off the first two ports 404. Optional port plugs 444 can also be used to block off one or more ports 404 on the interior interface of nozzle 130 to minimize or even eliminate, e.g., disruptions to flow through nozzle 130 by gas 140 and solid powder materials 111, 121. One or more ports 404 can also be unused without plugging by port plugs 444. In some embodiments, unused ports 404 do not use port plugs 444 but are configured such that port plugs 444 are not necessary even when gas 140 is flowing through nozzle 130.

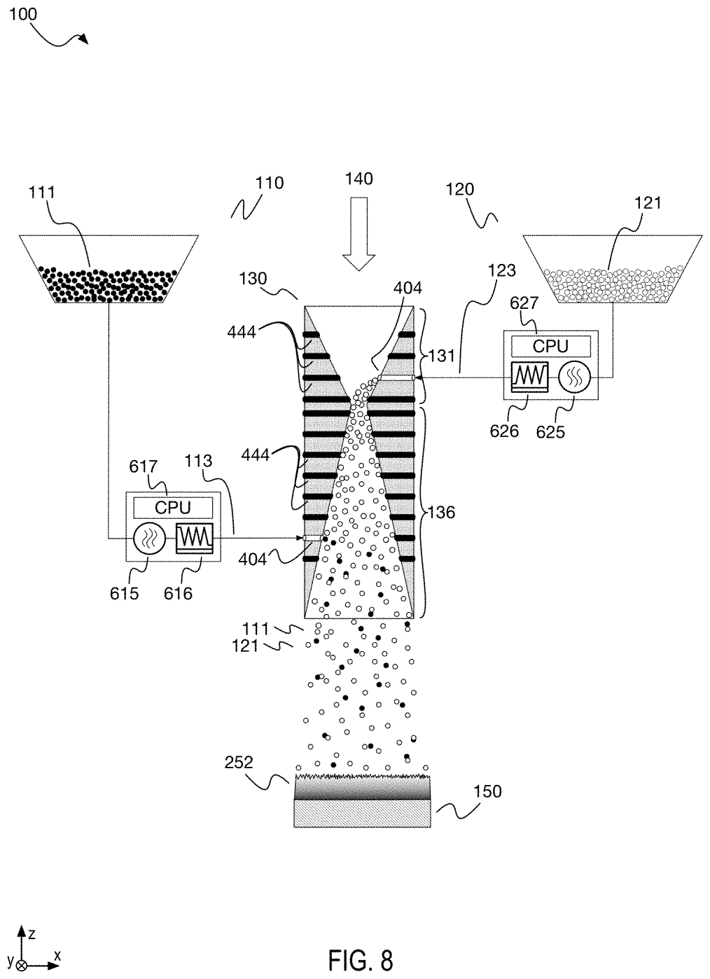

FIG. 8 illustrates a cross-sectional side view of an example cold-spray system 100 with multiple feed systems 110, 120 and nozzle 130, which includes many ports 404 and port plugs 444, arranged in accordance with at least some implementations of the present disclosure. FIG. 8 shows how a feed rate can be simply adjusted to easily change a film composition. As shown in FIG. 8, much like the example shown in FIG. 7, nozzle 130 includes a convergent section 131, a divergent section 136, and many ports 404 for making connections to feed systems 110, 120 (or other feed systems). Except for the two ports 404 used for making connections 113, 123 to feed systems 110, 120, all ports 404 shown are filled by port plugs 444 and blocked off from making further connections to feed systems. Feed systems 110, 120 independently deliver solid powder materials 111, 121 to nozzle 130. Feed systems 110, 120 include heaters 615, 625, conveyors 616, 626, and controllers 617, 627. Gas 140 flows downward and into nozzle 130, where it acts as a carrier fluid for solid powder materials 111, 121. The mixture of gas 140 and solid powder materials 111, 121 spray out of divergent section 136 and nozzle 130 towards substrate 150. Solid powder materials 111, 121 are deposited on substrate 150 to form a deposited film 252, which can be seen to have a graded composition. Deposited film 252 is a gradient film with darker composition at its interface with substrate 150 and lighter composition as a z-height of deposited film 252 increases to the nozzle side of deposited film 252.

The example of FIG. 8, in comparing to and contrasting with the example of FIG. 7, illustrates how the gradient of deposited film 252 is made. The same solid powder materials 111, 121 are being delivered by the same feed systems 110, 120 to the same ports on nozzle 130 by way of the same connections 113, 123. However, conveyor 616 (as controlled by controller 617) is delivering solid powder material 111 at a lower feed rate in FIG. 8, as evidenced by the lower concentration (relative to FIG. 7) of solid powder material 111 in divergent section 136 and being sprayed out of nozzle 130 towards substrate 150. The graded composition of deposited film 252, from a darker composition at bottom to a lighter composition at a highest z-height, shows the effect of keeping constant the feed rate of the lighter solid powder material 121 while lowering the feed rate of the darker solid powder material 111. In some embodiments, controllers 617, 627 separately control the feed rates of solid powder materials 111, 121 and vary one or more feed rates to create deposited films with graded variations in composition. In some embodiments, a feed rate for solid powder material 111 is increased while a feed rate for solid powder material 121 is held constant. In some embodiments, as here, a feed rate for solid powder material 111 is decreased while a feed rate for solid powder material 121 is held constant.

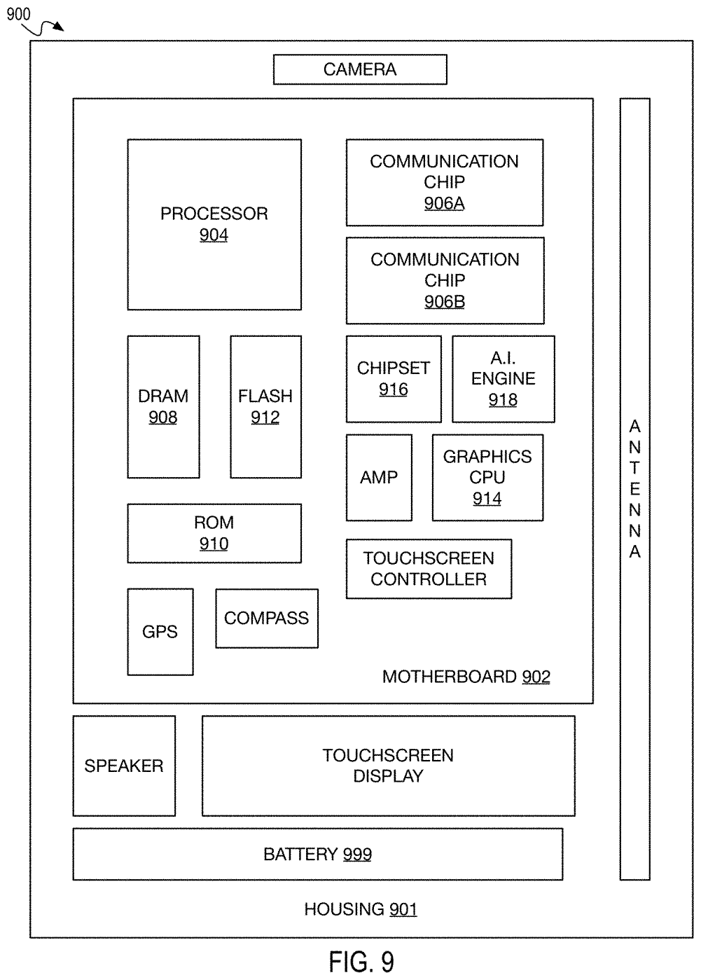

FIG. 9 illustrates an electronic system, specifically a computing device 900, arranged in accordance with at least some implementations of the present disclosure. Computing device 900 may be used for controlling the feed rates and temperatures in feed systems that deliver solid powder materials to cold-spray nozzles. Computing device 900 may include a housing 901 having a board 902 disposed therein. Computing device 900 may include a number of integrated circuit components, including but not limited to a processor 904, at least one communication chip 906A, 906B (including Network Devices or Processors), volatile memory 908 (e.g., DRAM), non-volatile memory 910 (e.g., ROM), flash memory 912, a graphics processor or CPU 914, a digital signal processor (not shown), a crypto processor (not shown), a chipset 916, an Artificial Intelligence (A.I.) Engine 918, an antenna, a display (touchscreen display), a touchscreen controller, a battery 999 (or other power supply), an audio codec (not shown), a video codec (not shown), a power amplifier (AMP), a global positioning system (GPS) device, a compass, an accelerometer (not shown), a gyroscope (not shown), a speaker, a camera, and a mass storage device (not shown) (such as hard disk drive, compact disk (CD), digital versatile disk (DVD), and so forth). Any of the integrated circuit components may be physically and electrically coupled to board 902. In some implementations, at least one of the integrated circuit components may be a part of processor 904.

The communication chip enables wireless communications for the transfer of data to and from the computing device. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device may include a plurality of communication chips. For instance, a first communication chip may be dedicated to shorter range wireless communications such as Wi-Fi and Bluetooth and a second communication chip may be dedicated to longer range wireless communications such as GPS, EDGE, GPRS, CDMA, WiMAX, LTE, Ev-DO, and others.

The term “processor” may refer to any device or portion of a device that processes electronic data from registers and/or memory to transform that electronic data into other electronic data that may be stored in registers and/or memory.

The entire computing device 900 or at least one of the integrated circuit components within computing device 900 may be used for controlling one or more delivery parameters of solid powder material feed systems for cold-spray deposition. In some embodiments, processor 904 controls the energization of feed system heaters (e.g., timing and supply voltages and/or frequencies). In some embodiments, processor 904 receives temperature data from one or more feed system temperature sensors. In some embodiments, processor 904 controls the energization of feed system conveyors (e.g., timing and supply voltages and/or frequencies). In some embodiments, volatile memory 908, non-volatile memory 910, and flash memory 912 are used by computing device 900 for storing programming code and/or data (e.g., from feed system temperature sensors). In some embodiments, computing device 900 uses communication chips 906A and 906B to receive data (e.g., from feed system temperature sensors) and transmit control signals (e.g., to feed system heaters and conveyors).

In various implementations, the computing device may be a laptop, a netbook, a notebook, an ultrabook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the computing device may be any other electronic device that processes data.

It is understood that the subject matter of the present description is not necessarily limited to specific applications illustrated in FIGS. 1-9. The subject matter may be applied to other deposition applications, as well as any appropriate manufacturing application, as will be understood to those skilled in the art.

The following examples pertain to further embodiments, and specifics in the examples may be used anywhere in one or more embodiments.

In one or more first embodiments, a deposition system comprises a first feed system, comprising a first controller, a first heater, a first temperature sensor, and a first conveyor, the first feed system to deliver a first solid powder material, and to control a first feed temperature and a first feed rate of the first solid powder material, a second feed system, comprising a second controller, a second heater, a second temperature sensor, and a second conveyor, the second feed system to deliver a second solid powder material, and to control a second feed temperature and a second feed rate of the second solid powder material, and a nozzle comprising a convergent section, a divergent section in fluid communication with the convergent section, a first connection to the first feed system, and a second connection to the second feed system, the nozzle to receive a carrier fluid in the convergent section and to spray at least portions of the carrier fluid and the first and second solid powder materials out of the divergent section.

In one or more second embodiments, further to the first embodiments, the first connection and second connection are directly coupled to the convergent section of the nozzle.

In one or more third embodiments, further to the first or second embodiments, the first connection and second connection are directly coupled to the divergent section of the nozzle.

In one or more fourth embodiments, further to the first through third embodiments, the first connection is directly coupled to the convergent section of the nozzle and the second connection is directly coupled to the divergent section of the nozzle.

In one or more fifth embodiments, further to the first through fourth embodiments, the first solid powder material comprises at least one of a metal, a ceramic, or a polymer.

In one or more sixth embodiments, further to the first through fifth embodiments, the second solid powder materials comprise copper, aluminum, nickel, diamond, or polyimide.

In one or more seventh embodiments, further to the first through sixth embodiments, the first feed rate is controlled independent of the second feed rate and the second feed rate is controlled independent of the first feed rate.

In one or more eighth embodiments, further to the first through seventh embodiments, the first feed temperature is controlled independent of the second feed temperature and the second feed temperature is controlled independent of the first feed temperature.

In one or more ninth embodiments, further to the first through eighth embodiments, the nozzle comprises one or more additional connections in one or more positions distinct from the first and second connections, the one or more additional connections configured to receive the first and second solid powder materials from the first and second feed systems or to receive one or more additional solid powder materials from one or more additional feed systems.

In one or more tenth embodiments, further to the first through ninth embodiments, the one or more additional feed systems, comprising one or more additional controllers, one or more additional heaters, one or more additional temperature sensors, and one or more additional conveyors, deliver one or more additional solid powder materials and control one or more additional feed temperatures and one or more additional feed rates of the one or more additional solid powder materials, wherein the nozzle is configured to receive the one or more additional solid powder materials from the one or more additional feed systems.

In one or more eleventh embodiments, an apparatus comprises a nozzle with a convergent section, a divergent section, and a throat therebetween, the nozzle to receive a gas in the convergent section, to accelerate the gas, and to send the gas out of the divergent section, and a plurality of ports on the nozzle, the ports to receive solid powder materials for admission into the gas, with one or more ports in the convergent section and one or more ports in the divergent section.

In one or more twelfth embodiments, further to the eleventh embodiments, the one or more ports in the convergent section or the one or more ports in the divergent section comprises two or more ports.

In one or more thirteenth embodiments, further to the eleventh or twelfth embodiments, one or more ports not receiving solid powder materials are plugged.

In one or more fourteenth embodiments, a method comprises delivering a carrier gas to a nozzle comprising convergent and divergent sections, heating a first solid powder materials to a first temperature, heating a second solid powder materials to a second temperature, delivering the first solid powder materials to a first position of the nozzle, delivering the second solid powder materials to a second position of the nozzle, and spraying at least portions of the first and second solid powder materials out of the divergent section.

In one or more fifteenth embodiments, further to the fourteenth embodiments, the first and second positions are in the convergent section.

In one or more sixteenth embodiments, further to the fourteenth or fifteenth embodiments, the first and second positions are in the divergent section.

In one or more seventeenth embodiments, further to the fourteenth through sixteenth embodiments, the first position is in the convergent section and the second position is in the divergent section.

In one or more eighteenth embodiments, further to the fourteenth through seventeenth embodiments, the first temperature is adjusted independent of the second temperature.

In one or more nineteenth embodiments, further to the fourteenth through eighteenth embodiments, the first solid powder materials are delivered to the nozzle at a first feed rate and the second solid powder materials are delivered to the nozzle at a second feed rate.

In one or more twentieth embodiments, further to the fourteenth through nineteenth embodiments, the first feed rate is adjusted independent of the second feed rate.

Having thus described in detail embodiments of the present invention, it is understood that the invention defined by the appended claims is not to be limited by particular details set forth in the above description, as many apparent variations thereof are possible without departing from the spirit or scope thereof.

We claim:

1. A deposition system, comprising:
a first feed system, comprising a first controller, a first heater, a first temperature sensor, and a first conveyor, the first feed system to deliver a first solid powder material, and to control a first feed temperature and a first feed rate of the first solid powder material;
a second feed system, comprising a second controller, a second heater, a second temperature sensor, and a second conveyor, the second feed system to deliver a second solid powder material, and to control a second feed temperature and a second feed rate of the second solid powder material; and
a nozzle comprising a convergent section, a divergent section in fluid communication with the convergent section, a first connection to the first feed system, and a second connection to the second feed system, the nozzle to receive a carrier fluid in the convergent section and to spray at least portions of the carrier fluid and the first and second solid powder materials out of the divergent section.

2. The deposition system of claim 1, wherein the first connection and second connection are directly coupled to the convergent section of the nozzle.

3. The deposition system of claim 1, wherein the first connection and second connection are directly coupled to the divergent section of the nozzle.

4. The deposition system of claim 1, wherein the first connection is directly coupled to the convergent section of the nozzle and the second connection is directly coupled to the divergent section of the nozzle.

5. The deposition system of claim 1, wherein the first solid powder material comprises at least one of a metal, a ceramic, or a polymer.

6. The deposition system of claim 5, wherein the second solid powder material comprise copper, aluminum, nickel, diamond, or polyimide.

7. The deposition system of claim 1, wherein the first feed rate is controlled independent of the second feed rate and the second feed rate is controlled independent of the first feed rate.

8. The deposition system of claim 1, wherein the first feed temperature is controlled independent of the second feed temperature and the second feed temperature is controlled independent of the first feed temperature.

9. The deposition system of claim 1, wherein the nozzle comprises one or more additional connections in one or more positions distinct from the first and second connections, the one or more additional connections configured to receive the first and second solid powder materials from the first and second feed systems or to receive one or more additional solid powder materials from one or more additional feed systems.

10. The deposition system of claim 1, further comprising:
one or more additional feed systems, comprising one or more additional controllers, one or more additional heaters, one or more additional temperature sensors, and one or more additional conveyors, the one or more additional feed systems to deliver one or more additional solid powder materials and to control one or more additional feed temperatures and one or more additional feed rates of the one or more additional solid powder materials, wherein the nozzle is configured to receive the one or more additional solid powder materials from the one or more additional feed systems.

11. An apparatus, comprising:
a nozzle with a convergent section, a divergent section, and a throat therebetween, the nozzle to receive a gas in the convergent section, to accelerate the gas, and to send the gas out of the divergent section; and
a plurality of ports on the nozzle, the ports to receive solid powder materials for admission into the gas, with one or more ports in the convergent section and one or more ports in the divergent section.

12. The apparatus of claim 11, wherein the one or more ports in the convergent section or the one or more ports in the divergent section comprises two or more ports.

13. The apparatus of claim 11, wherein one or more ports not receiving solid powder materials are plugged.

14. A method, comprising:
delivering a carrier gas to a nozzle comprising convergent and divergent sections;
heating a first solid powder material to a first temperature;
heating a second solid powder material to a second temperature;
delivering the first solid powder material to a first position of the nozzle;
delivering the second solid powder material to a second position of the nozzle; and
spraying at least portions of the first and second solid powder materials out of the divergent section.

15. The method of claim 14, wherein the first and second positions are in the convergent section.

16. The method of claim 14, wherein the first and second positions are in the divergent section.

17. The method of claim 14, wherein the first position is in the convergent section and the second position is in the divergent section.

18. The method of claim 14, wherein the first temperature is adjusted independent of the second temperature.

19. The method of claim 14, wherein the first solid powder material are delivered to the nozzle at a first feed rate and the second solid powder material are delivered to the nozzle at a second feed rate.

20. The method of claim 19, wherein the first feed rate is adjusted independent of the second feed rate.
